(19) United States
(12) Patent Application Publication
(10) Pub. No.: US 2004/0193860 A1
(43) Pub. Date: Sep. 30, 2004

(54) Methods and apparatus to export information from hardware devices

(76) Inventors: Michael A. Rothman, Gig Harbor, WA (US); Vincent J. Zimmer, Federal Way, WA (US)

Correspondence Address: GROSSMAN & FLIGHT LLC, Suite 4220, 20 North Wacker Drive, Chicago, IL, 60606-6357, US

(21) Appl. No.: 10/395,729

(22) Filed: Mar. 24, 2003

(51) Int. Cl. G06F 15/177

(52) U.S. Cl. 713/1

(57) ABSTRACT

Methods and apparatus to export information from hardware devices are disclosed. The method may include, for example, initializing a peripheral device in a pre-boot environment and receiving from the peripheral device an information package. The method may further include storing the information package in a memory arranged in a manner related to contents of the information package and providing a user interface through which at least some of the contents of the information package are displayed to a user.

### TECHNICAL FIELD

The present disclosure pertains to computing systems and, more particularly, to methods and apparatus to export information from hardware devices.

### BACKGROUND

Processor-based systems, such as personal computers, typically include a motherboard on which a main processor and memory are disposed. Additionally, the motherboard includes a number of slots into which peripherals, or devices, may be installed. For example, a personal computer may include peripherals such as a hard drive controller, a display or graphics adapter, a network adapter and a modem, each of which is usually provided by an independent hardware vendor (IHV) and each of which is installed into a slot on the motherboard or is in communication with the motherboard through other means (e.g., a cable connection).

Each peripheral associated with the processor system includes a memory portion, commonly referred to as an option read only memory (ROM) that stores configuration or operation information and data for the peripheral. Typically, user configuration of peripherals, or review of versioning information stored in the option ROM, is available during boot of the main processor through the use of configuration utilities associated with each peripheral. Each configuration utility is accessed by user actuation of specific hot keys that are specified by IHVs. For example, a disk drive controller IHV may enable a user to access its configuration utility to review versioning information in the option ROM of the disk drive controller if a user presses the F1 key after the splash screen for the disk drive controller manufacturer is displayed to the user during initialization of the controller by the processor. Due in part to lack of standardization, it is very rare that configuration information for two peripherals is accessed in the same manner. Accordingly, a user seeking to review or alter the configuration information for a peripheral must actuate the appropriate hot key for the peripheral at a particular point in time.

As computing systems become more complex and the number of peripherals to be configured grows, more time, in aggregate, is required to allow users to access the various configuration utilities of the peripherals via hot keys. However, in many instances, operating system (OS) software vendors specify a maximum period of time, such as, for example, seven seconds, between processor power-up and when the processor begins to boot the OS. Accordingly, while there are generally more peripherals to be configured, the time allotted to access the configuration utilities of such peripherals must be fit within the required timeframe. As the number of peripherals to be configured increases and the specified time between processor power-up and OS boot stays fixed, the window of time in which a user can access the configuration information of a particular device decreases. A user desiring to configure a peripheral must watch screen messages as a system boots and must stay perched on a keyboard and intervene with the proper hot key at the appropriate time. In practical effect, the window for actuating the proper hot key is small and may require one or more subsequent re-boots to enable a user to actuate the appropriate hot key within the appropriate window of time. This situation is less than optimal, as the user may become frustrated when numerous attempts are made to access the configuration information of a particular peripheral.

### BRIEF DESCRIPTION OF THE DRAWINGS

FIG. 1 is a diagram of an example processor system.

FIG. 2 is flow diagram of an example boot process that may be carried out by the processor of FIG. 1.

FIG. 3 is a diagram of an example device exporting information.

FIG. 4 is a flow diagram of an example process to add exported information to a device manager.

FIG. 5 is a diagram illustrating how various example interface screens of a firmware interface may be interrelated.

### DETAILED DESCRIPTION

Although the following discloses example systems including, among other components, software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the following describes example systems, persons of ordinary skill in the art will readily appreciate that the examples are not the only way to implement such systems.

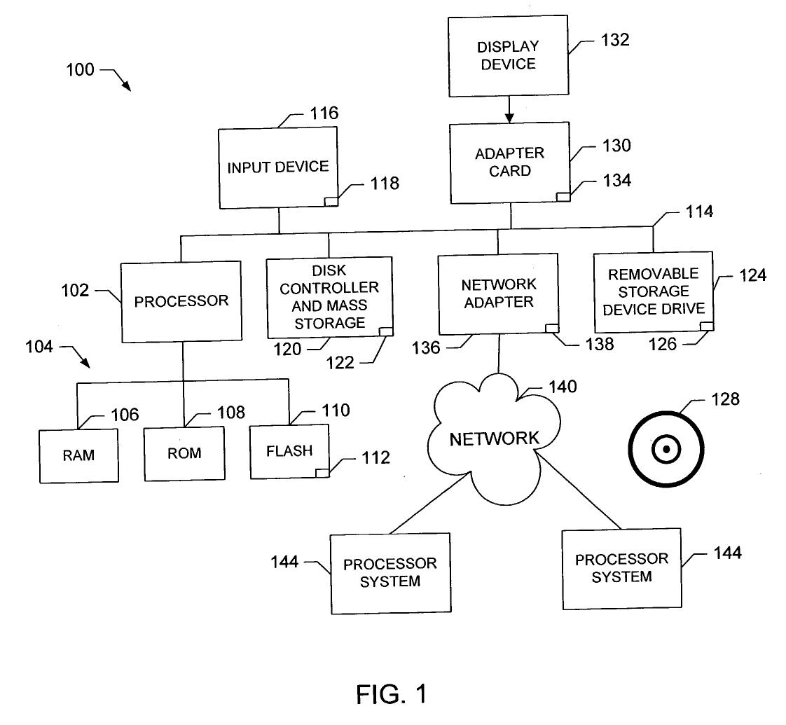

Turning now to FIG. 1, an example processor system 100 includes a processor 102 having associated system memory 104. The system memory 104 may include one or more of a random access memory (RAM) 106, a read only memory (ROM) 108 and a flash memory 110. The flash memory 110 of the illustrated example includes a boot block 112.

The processor 102, in the example of FIG. 1, is coupled to an interface, such as a bus 114 to which other peripherals or devices are interfaced. In the illustrated example, the peripherals interfaced to the bus 114 include an input device 116 having an associated memory 118, a disk controller and mass storage device 120 (referred to hereinafter for example purposes as a Brand V Disk Controller) having an associated memory 122 and a removable storage device drive 124 also including an associated memory 126. The removable storage device drive 124 may include associated removable storage media 128, such as magnetic or optical media.

The example processor system 100 of FIG. 1 also includes an adapter card 130, which is a peripheral coupled to the bus 114 and further coupled to a display device 132. The adapter card 130, which interfaces the display device 132 to the bus 114, includes an associated memory 134.

The example processor system 100 may be, for example, a conventional desktop personal computer, a notebook computer, a workstation or any other computing device. The processor 102 may be any type of processing unit, such as a microprocessor from the Intel® Pentium® family of microprocessors, the Intel® Itanium® family of microprocessors, and/or the Intel XScale® family of processors.

The memories 106, 108 and 110, which form some or all of the system memory 104, may be any suitable memory devices and may be sized to fit the storage demands of the system 100. In particular, the flash memory 110 is a low-cost, high-density, high-speed architecture having low power consumption and high reliability. The flash memory 110 is a non-volatile memory that is accessed and erased on a block-by-block basis.

The input device 116 may implemented by a keyboard, a mouse, a touch screen, a track pad or any other device that enables a user to provide information to the processor 102.

The display device 132 may be, for example, a liquid crystal display (LCD) monitor, a cathode ray tube (CRT) monitor or any other suitable device that acts as an interface between the processor 102 and a user via the adapter card 130. The adapter card 130 is any device used to interface the display device 132 to the bus 114. Such cards are presently commercially available from, for example, Creative Labs and other like vendors.

The mass storage device 120 may be, for example, a conventional hard drive or any other magnetic or optical media that is readable by the processor 102.

The removable storage device drive 124 may, for example, be an optical drive, such as a compact disk-recordable (CD-R) drive, a compact disk-rewritable (CD-RW) drive, a digital versatile disk (DVD) drive or any other optical drive. It may alternatively be, for example, a magnetic media drive. The removable storage media 128 is complimentary to the removable storage device drive 124, inasmuch as the media 128 is selected to operate with the drive 124. For example, if the removable storage device drive 124 is an optical drive, the removable storage media 128 may be a CD-R disk, a CD-RW disk, a DVD disk or any other suitable optical disk. On the other hand, if the removable storage device drive 124 is a magnetic media device, the removable storage media 124 may be, for example, a diskette or any other suitable magnetic storage media.

The example processor system 100 also includes a network adapter 136 (i.e., a processor peripheral), such as, for example, an Ethernet card or any other card that may be wired or wireless having an associated memory 138 in which device information for the network adapter 136 is stored. For example purposes, the network adapted is referred to hereinafter as a Brand Y Network Adapter Card. The network adapter 136 provides network connectivity between the processor 102 and a network 140, which may be a local area network (LAN), a wide area network (WAN), the Internet or any other suitable network. As shown in FIG. 1, further processor systems 144 may be coupled to the network 140, thereby providing for information exchange between the processor 102 and the processors of the processor systems 144.

The associated memories 118, 122, 126, 134 and 138 of the foregoing peripherals may be referred to as option ROMs and are typically implemented by flash memory. As will be readily appreciated by those having ordinary skill in the art, option ROMs store information germane to the configuration and versioning of the processor peripherals with which the option ROMs are associated. For example, option ROMs may store firmware versions and revision dates, device characteristics, device memory capacities, lists of supported communication protocols, power requirements and flash memory sizes. The information stored in an option ROM is referred to hereinafter as device information.

As described in detail hereinafter, the disclosed system enables the processor 102 to receive device information from at least some of the peripherals (e.g., the peripherals 116, 120, 124, 130 and/or 136), to present such device information to a user and to enable a user, through a system interface, to modify information stored in the associated memories (e.g., the memories 118, 122, 126, 134 and 138) in a pre-boot environment. The disclosed system is OS agnostic because the system does not require drivers and user-mode applications that are specific to each peripheral to modify the contents of the associated memories of the peripherals.

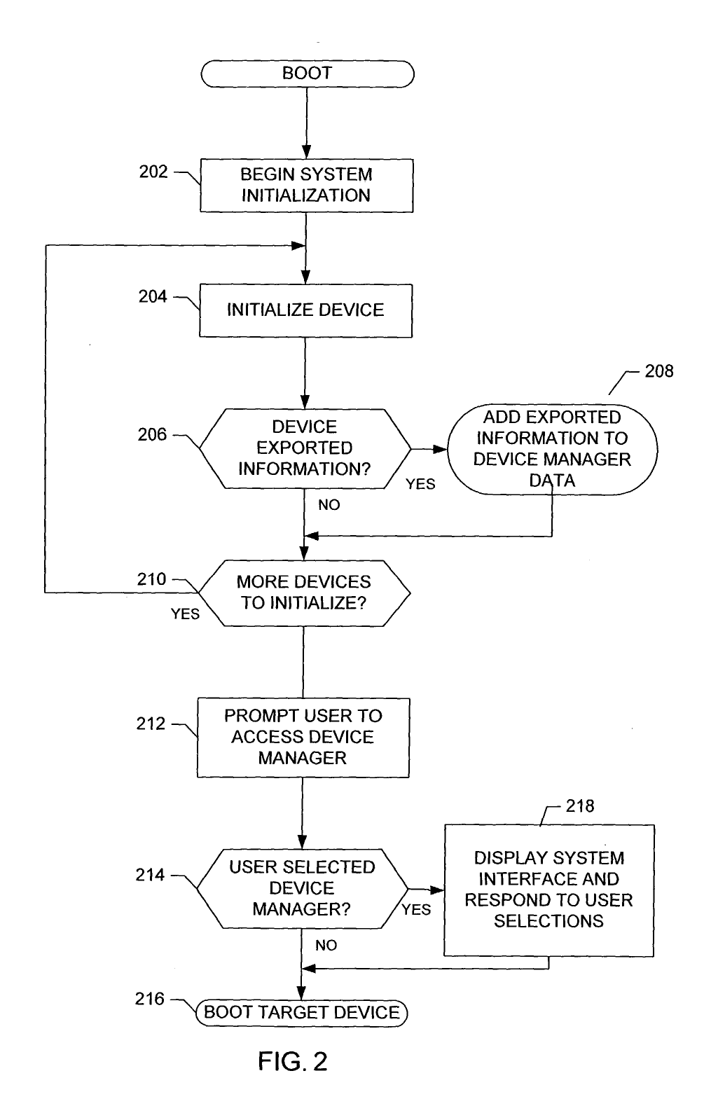

When power is applied to the processor 102 of FIG. 1 or the processor 102 experiences a reset, the processor 102 commences a boot process. An example boot process is shown in FIG. 2. In the illustrated example, the boot process is dictated by instructions stored in the boot block 112. These instructions cause the processor 102 to begin system initialization (block 202). System initialization may include, but is not limited to zeroing registers, resetting counters and the like.

After system initialization has begun, a peripheral device is selected for initialization (block 204). The selected peripheral for initialization may be any one of the peripherals (e.g., the peripherals 116, 120, 124, 130 and/or 136) and may be selected in any manner. For example, the selection may be random or may be ordered. In an ordered selection, the peripherals may be selected by sequentially selecting slots on the motherboard into which the peripherals are selected. After a device is selected for initialization (e.g., the input device 116) and initialization is commenced (block 204), it is determined if the selected device is capable of exporting information about itself (block 206). If the selected device is able to export information about itself (block 206), a process that adds the exported information to device manager data is initiated (block 208).

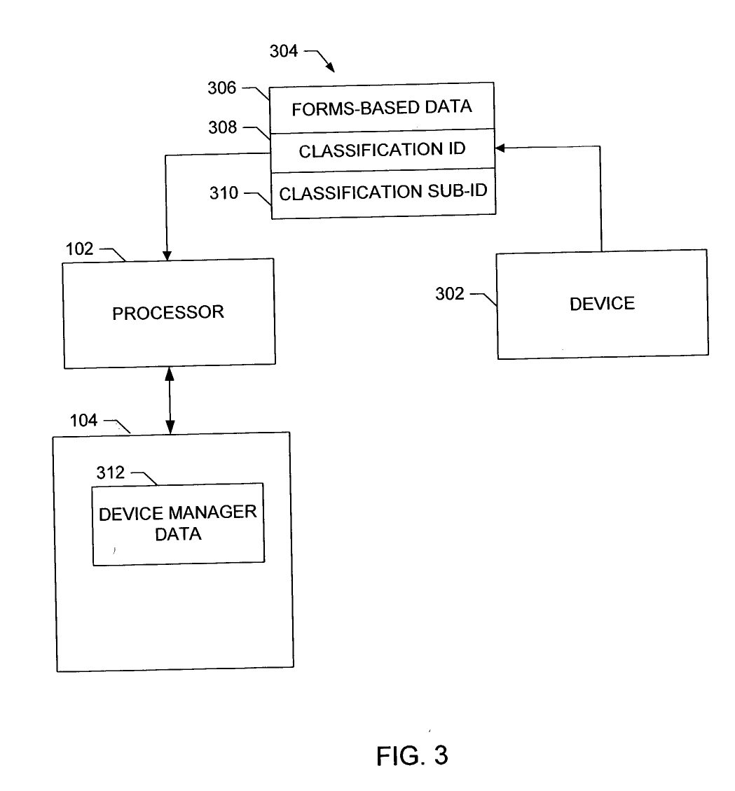

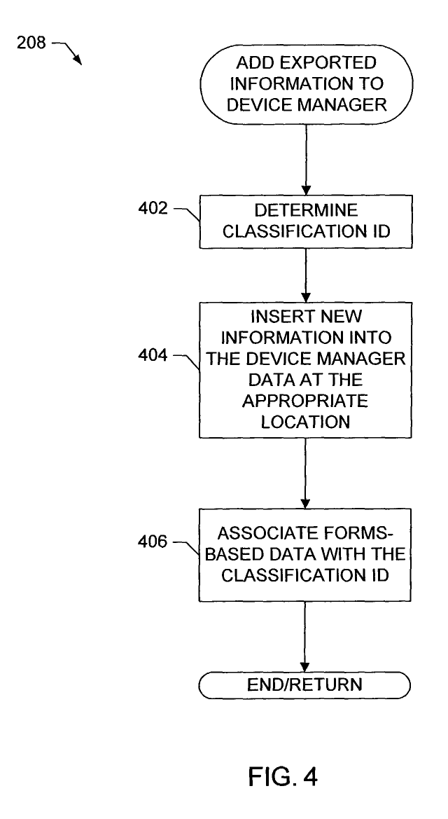

Exportation of device information is shown in FIG. 3, in which a device 302, which represents any of the peripherals (e.g., the peripherals 116, 120, 124, 130 and/or 136), exports from the peripheral option ROM, in response to the initialization of the device (block 204), a device information package 304. The device information package 304 of the example of FIG. 3 includes forms-based data 306, a classification ID 308 and a classification sub-ID 310. The device information package 304 is exported from the device 302 to the processor 102. As described in detail in conjunction with FIG. 4, the exported information is stored in a device data manager 312 in memory 104. The following is a brief description of the details of the device information package 304 of FIG. 3.

In the illustrated example, the forms-based data 306 is information that dictates textual information that will be displayed to the user in the form of interrogatories and statements and also indicates how the responses of a user should be processed. The information in the forms-based data 306 is typically string information, such as hyperlinks that enable a user to jump to other information, checkbox(es) that enable a user to indicate the desire to enable or disable particular function(s) of the peripheral. For example, forms-based data 306 may include a query such as “Do you want to enable the peripheral?” followed by a checkbox that the user can check or uncheck through the use of the input device 116 (FIG. 1).

In the illustrated example, the classification ID 308 is digital information in the form of bits or one or more bytes representative of the peripheral type. The peripheral types and the byte values to which the types correspond may be standardized. For example, any input device may have a classification ID value of 52 hexadecimal (hex). Accordingly, whether an input device is a keyboard, a mouse or any other input device, the classification ID exported by such a device would be 52 hex. As a further example, all disk controllers may output a classification ID of 7D hex. As described below in connection with FIG. 4, the information from various peripherals may be hierarchically arranged according to classification ID values, where peripherals with identical classification IDs are grouped together for ease of user understanding when accessing a utility used to configure such devices.

In the illustrated example, the classification sub-ID 310 is an optional part of the device information package 304 that may be implemented by additional bits or bytes of information. Conceptually, the classification sub-ID 310 is a theme or template that dictates the format in which forms-based data 306 from the peripheral is displayed to a user. For example, a classification sub-ID of 4F hex could be used to indicate that all textual information should be displayed in a font of eight-point, times new roman. Additionally, the 4F hex classification sub-ID could indicate that the background on which the text is displayed is to be blue and the text displayed thereon is to be white.

An example process for adding exported information to device manager data (block 208 of FIG. 2) is shown in FIG. 4. As shown in FIG. 4, when information is exported by a peripheral (e.g., the device 210 of FIG. 3), the processor first determines the classification ID exported from the peripheral (block 402) by examining the device information package 304 provided by the peripheral 302.

After the classification ID is determined (block 402), the information from the device information package 304 is inserted into the device manager data 312 at an appropriate location (block 404). The information in the device manager data 312 may be organized in any number of different ways. In an example, organization is by classification ID 308. Sorting the device manager data 312 by classification ID 308 groups all like-devices together. Continuing the foregoing example, all input devices, which by definition have classification IDs of 52 hex, would be grouped together and all disk controllers, which have classification IDs of 7D hex would be grouped together.

After the new information is inserted (block 404), the forms-based data 306 is associated with the classification ID 308 (block 406). Accordingly, as described below, when the device manager information is presented to a user, the text and queries related to a particular classification ID are associated with that classification ID. After the forms-based data is associated with the classification ID (block 406), control returns to block 210 of FIG. 2. If there are more devices to initialize (block 210), control returns to block 404 to initialize another uninitialized device.

Conversely, if all devices have been initialized (block 210), the user is prompted to indicate a desire to access a device manager that enables a user, through a graphical or text-based user interface, to configure the peripherals (block 212). For example, a prompt may be as simple as displaying text to a user that instructs the user to actuate a particular key to access the device manager. As described below, the device manager accesses the device manager data 312 and provides a single interface through which multiple different peripherals may be configured.

After the user is prompted to access the system interface, (block 212), it is determined if the user has indicated a desire to access the device manager (block 214). As with most peripheral setup access procedures, the user may indicate a desire to access the system interface by actuating a particular key during a particular interval of time. Alternatively, the user could be required to actuate a number of different keys simultaneously at a particular point in time to access the device manager. If the user has not manifested a desire to access the device manager (block 214), a target device is booted and the process terminates (block 218).

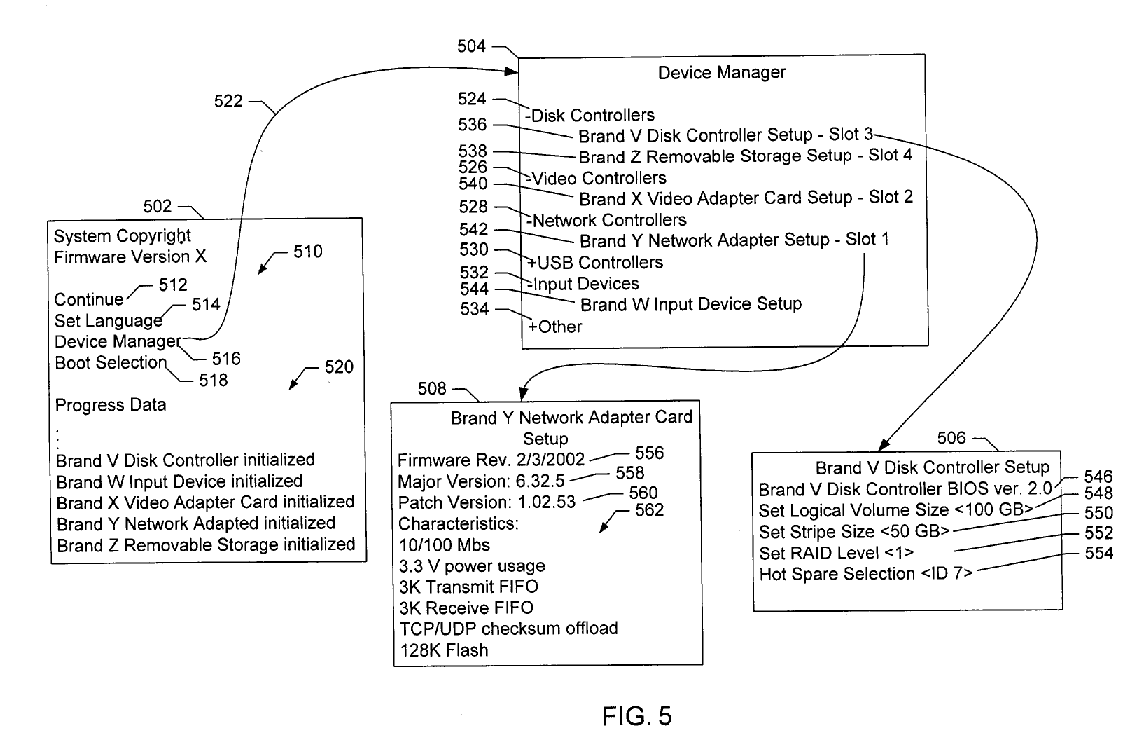

If, however, the user has indicated a desire to access the system interface (block 214), the system interface is displayed to the user (block 218). An example system interface 500 shown in FIG. 5 includes a main menu 502, a device manager interface 504 and additional interfaces 506, 508 revealing further detail of items shown in the device manager interface 504. In the illustrated example, the interface 506 pertains to the Brand V Disk Controller 120 and the interface 508 pertains to the Brand Y Network Adapter Card 136.

In the example of FIG. 5, the main menu 502 generally includes a selection portion 510, which includes a number of menu items 512-518 that are user-selectable, and a status portion 520 reflecting the status of the initialization process. Upon the user indicating a desire to access the system interface 502 (see block 214, FIG. 2), the user is presented with the main menu 502. From the main menu, the user is able to select the CONTINUE menu item 512, which closes the system interface 500 and causes the processor 102 to continue with the boot process (block 216 of FIG. 2). The user is also able to select the language in which the system interface 500 is presented by selecting the SET LANGUAGE menu item 514. The user is able to select the DEVICE MANAGER menu item 516, which as described below, causes the display of the device manager interface 504. Additionally, the user is able to select the BOOT SELECTION menu item 518, which enables the user to select a device from which the processor 102 is to boot.

The selection of the DEVICE MANAGER menu item 516 causes the main menu 502 to disappear. It also causes the device manager interface 504 to be displayed, as represented by the arrow 522. The device manager interface 504 includes information from the device manager data 312 within the memory 104. In this example, the information in the device manager data 312 is arranged according to classification IDs exported by the peripherals (e.g., the peripherals 116, 120, 124, 130 and/or 136). Accordingly, as shown in the device manager interface 504 of FIG. 5, the entries are grouped into categories corresponding to classification IDs stored in the device manager data 312. In particular, the information in the example device manager interface 504 of FIG. 5 is grouped in the following categories: DISK CONTROLLERS 524, VIDEO CONTROLLERS 526, NETWORK CONTROLLERS 528, universal serial bus (USB) CONTROLLERS 530, and INPUT DEVICES 532. Each of these categories corresponds to one or more classification IDs. Additionally, the example device manager interface 504 of FIG. 5 includes a category of OTHER 534, in which unknown or unrecognized classification IDs may be grouped. The OTHER category provides compatibility for new device types or classification IDs that may be created after the device management system is deployed. The listing of categories shown in the device manager interface 504 indicates that at least one peripheral exported information to the device manager data 312 in each of the listed categories. If there were not at least one peripheral in a particular displayed category, that category would not appear in the device manager interface 504.

Each of the categories 524-534 is preceded by an indicator that informs the user if a particular category is expanded to reveal all of the peripherals within that category. In particular, categories 524, 526, 528 and 532 are preceded by a minus sign (−) that indicates the categories are expanded to reveal the peripherals in the categories. Conversely, categories 530 and 534 are preceded by a plus sign (+), which indicates that there are peripherals within those categories, but the listing of such devices is not shown in the device manager interface 504. As with most Windows® applications, a user may select a plus sign to reveal the contents of a category and may select a minus sign to hide the contents of a category. The selection may be carried out by input devices, such as, for example, a keyboard, a mouse or any other selection device.

With further reference to the device manager interface 504, one or more peripherals are displayed under categories 524-528 and 532. In particular, peripheral displays 536 and 538 are displayed under category 524 and peripheral displays 540, 542 and 544 are displayed under categories 526, 528 and 532, respectively. In general, each of the peripheral displays may be selected by the user to cause further information to be presented to the user. The following description pertains to peripheral displays 536 and 542, which are related to the Brand Y Network Adapter Card 136 and the Brand V Disk Controller 120, respectively, and the information displayed to a user when the user selects the displays.

If a user selects the peripheral display 536 from the device manager interface 504, the user will be presented with the BRAND V DISK CONTROLLER SETUP interface 506 (hereinafter the interface 506) that reveals information pertinent to the Brand V Disk Controller 120 of FIG. 1. The interface 506 includes displays of, for example, a basic input/output system (BIOS) version 546, a logical volume size 548, a stripe size 550, a redundant array of inexpensive devices (RAID) level 552 and a hot spare selection 554. Through the use of the interface 506, a user may review the settings of the Brand V Disk Controller 120 of FIG. 1.

In addition to merely being able to review the settings of the Brand V Disk Controller 120, a user can alter certain settings of the controller 120. For example, by selecting the 100 GB value displayed in the interface 506, a user may be prompted to key in an alternate logical volume size. Of course, the device manager could limit the range of acceptable values for the logical volume size, thereby preventing a user from making a selection that would render the Brand V disk controller 120 unusable.

If a user selects the peripheral display 542 from the device manager interface 504, in the example of FIG. 5 the user is presented with the BRAND Y NETWORK ADAPTER CARD interface 508 (hereinafter the interface 508) that reveals information pertinent to the Brand Y Network Adapter Card 136 of FIG. 1. The interface 508 includes displays of, for example, a firmware revision 556, a major version 558, a patch version 560, as well as general characteristics 562 of the device.

While a user is able to alter certain settings of the Brand V Disk Controller 120 via the interface 506, not all devices or peripherals include parameters that may be altered. For example, the Brand V Network Adapter 136 via the interface 508 does not include any alterable characteristics. Accordingly, interfaces to devices or peripherals may be used to review settings of devices, but are not necessarily usable to alter device settings.

Although certain apparatus, methods and articles of manufacture constructed in accordance with the teachings of the invention have been described herein, the scope of coverage of this patent is not limited thereto. On the contrary, this patent covers all apparatuses, methods and articles of manufacture of the teachings of the invention fairly falling within the scope of the appended claims either literally or under the doctrine of equivalents.

What is claimed is:

1. A method of collecting information from a peripheral device in a pre-boot environment, the method comprising:
initializing a peripheral device in a pre-boot environment;
receiving from the peripheral device an information package;
storing the information package in a memory, wherein the information package is stored in the memory in a location related to the contents of the information package; and
providing a user interface through which at least some of the contents of the information package are displayed to a user.

2. A method as defined by claim 1, further comprising determining if the peripheral device is capable of exporting the information package.

3. A method as defined by claim 1, wherein the information package includes at least one of forms-based data, a classification identifier and a sub-classification identifier.

4. A method as defined by claim 3, wherein the information package is stored in memory based on the classification identifier.

5. A method as defined by claim 4, wherein the classification identifier is related to a type of the peripheral device.

6. A method as defined by claim 3, wherein information presented to the user through the user interface is defined by the forms-based data.

7. A method as defined by claim 3, wherein information presented to the user through the user interface has an appearance defined by the sub-classification identifier.

8. A method as defined by claim 1, further comprising receiving from the user changes to information displayed to the user.

9. A method as defined by claim 1, further comprising prompting the user to enable the user to access the user interface.

10. An article of manufacture comprising a machine-accessible medium having a plurality of machine accessible instructions that, when executed, cause a machine to:
initialize a peripheral device in a pre-boot environment;
receive from the peripheral device an information package;
store the information package in a memory, wherein the information package is stored in the memory in a location related to the contents of the information package; and
provide a user interface through which at least some of the contents of the information package are displayed to a user.

11. An article of manufacture as defined by claim 10, further comprising instructions that, when executed, cause a machine to determine if the peripheral device is capable of exporting the information package.

12. An article of manufacture as defined by claim 10, wherein the information package includes at least one of forms-based data, a classification identifier and a sub-classification identifier.

13. An article of manufacture as defined by claim 10, wherein the information package is stored in memory in a location based on the classification identifier.

14. An article of manufacture as defined by claim 13, wherein the classification identifier is related to a type of the peripheral device.

15. An article of manufacture as defined by claim 13, wherein information presented to the user through the user interface is defined by the forms-based data.

16. An article of manufacture as defined by claim 13, wherein information presented to the user through the user interface has an appearance defined by the sub-classification identifier.

17. An article of manufacture as defined by claim 10, further comprising instructions that, when executed, cause a machine to receive from the user changes to information displayed to the user.

18. An article of manufacture as defined by claim 10, further comprising instructions that, when executed, cause a machine to prompt to the user to enable the user to access the user interface.

19. A system comprising:
a peripheral including a peripheral memory, wherein the peripheral memory includes an information package;
a memory; and
a processor coupled to the peripheral and the memory, wherein the processor is programmed to:
initialize the peripheral in a pre-boot environment;
receive from the peripheral the information package;
store the information package in the memory, wherein the information package is stored in the memory in a location related to the contents of the information package; and
provide a user interface through which at least some of the contents of the information package are displayed to a user.

20. A system as defined by claim 19, wherein the processor is further programmed to determine if the peripheral device is capable of exporting the information package.

21. A system as defined by claim 19, wherein the information package includes at least one of forms-based data, a classification identifier and a sub-classification identifier.

22. A system as defined by claim 21, wherein the information package is stored in memory based on the classification identifier.

23. A system as defined by claim 21, wherein the classification identifier is related to a type of the peripheral device.

24. A system as defined by claim 19, wherein information presented to the user through the user interface is defined by the forms-based data.

25. A system as defined by claim 19, wherein information presented to the user through the user interface has an appearance defined by the sub-classification identifier.

26. A system as defined by claim 19, wherein the processor is further programmed to receive from the user changes to information displayed to the user.

27. A system as defined by claim 19, wherein the processor is further programmed to prompt to the user to enable the user to access the user interface.
